(19) United States
(12) Patent Application Publication
(10) Pub. No.: US 2024/0021338 A1
(43) Pub. Date: Jan. 18, 2024

(54) ELECTROTECHNICAL FLUID AND A METHOD FOR MANUFACTURING THE SAME

(71) Applicant: Neste Oyj, Espoo (FI)

(72) Inventors: Virpi RÄMÖ, Porvoo (FI); Sonja KOUVA, Porvoo (FI)

(73) Assignee: Neste Oyj, Espoo (FI)

(21) Appl. No.: 18/252,565

(22) PCT Filed: Nov. 11, 2020
(86) PCT No.: PCT/FI2020/050743

§ 371 Date: May 11, 2023

(51) Int. Cl. H01B 3/22; C10G 7/04

(52) U.S. Cl. CPC H01B 3/22; C10G 7/04

(57) ABSTRACT

A method for producing an electrotechnical fluid composition is described. The method includes subjecting a renewable feedstock including free fatty acids and glycerides to ketonisation under ketonisation conditions, subjecting the ketonised renewable feedstock to hydrotreatment under hydrotreatment conditions to obtain a renewable paraffinic intermediate product, and subjecting the renewable paraffinic intermediate product to at least one fractionation to obtain the electrotechnical fluid composition, wherein the electrotechnical fluid composition fulfils the requirements according to IEC60296(2012) international standard.

### FIELD OF THE INVENTION

The present invention relates to a method for producing an electrotechnical fluid composition obtained from renewable raw materials, to a composition produced using said method and to a use of said composition.

### BACKGROUND

Liquid or gaseous electrotechnical fluids are used in electrical apparatuses such as transformers, capacitors, switchgears, bushings, etc. Electrotechnical fluids typically act as an electrically insulating medium separating the high voltage and grounded parts within the apparatus and functioning as a cooling medium to transfer the heat generated in the apparatus. In addition to the above mentioned basic functions, the electrotechnical fluid should comply with other necessary and desired requirements such as long operational life time, operation in wide range of temperatures, suitable kinematic viscosity and minimal environmental impact.

There is a growing end need for sustainable, biosourced and recycled alternatives in the field of electrotechnical fluids. Although there is an increased demand for products prepared from renewable feedstocks, the use of renewable feedstocks for the production of electrotechnical fluids, which electrotechnical fluids also fulfil the standard requirements for such fluids, has been difficult, making the use of renewable feeds for this purpose problematic.

WO2007/068795 A1 (to Neste Oil Oyj) describes a complex feed, which is diluted with hydrocarbons and processed by prehydrogenation, ketonisation, hydrodeoxygenation, stripping, hydroisomerisation, optional hydrofinishing, and distillation into a renewable base oil, renewable diesel as well as a renewable gasoline.

WO2014128227 discloses a renewable hydrocarbon based insulating fluid which comprises more than 70% isoparaffins. This disclosure does not teach how to produce a fluid which meets the required performance or the composition of a fluid which meets the required performance.

WO2018078024 discloses an electrotechnical fluid for an electric vehicle, having a boiling point in the range of from 200° C. to 400° C. and a boiling range below 80° C., said fluid comprising more than 95% isoparaffins and less than 3% naphthenes by weight, a biocarbon content of at least 95% by weight, containing less than 100 ppm aromatics by weight. This disclosure does not teach how to produce a fluid which meets the standard requirements or the cornposition of a fluid which meets the standard requirements.

### SUMMARY

An object of the present invention is to provide a method for producing hydrocarbon composition which is suitable as electrotechnical fluid composition and which alleviates the disadvantages discussed above. The present invention also relates to an electrotechnical fluid composition which fulfils the requirements according to IEC60296, and which electrotechnical fluid composition may be prepared by said method. In addition, the invention relates to the use of an electrotechnical fluid composition.

The present inventors have surprisingly found that a side stream of a Renewable Base Oil (RBO) process can be used for production of electrotechnical fluids which fulfil the standard requirements for such products, according to IEC60296. The inventors found that a part of the side stream from the RBO process surprisingly could be used for production of an electrotechnical fluid composition fulfilling the standard requirements, resulting in a full valorization of the renewable raw material, i.e. the feedstock that is used for the RBO process, since the waste streams thereby are reduced. This results in a more environmentally friendly process, since the waste stream from the RBO process is reduced, and instead is used as raw material for an electrotechnical fluid composition, thus also reducing the amount of other type of raw materials that otherwise would be used for producing the electrotechnical fluid composition.

In a preferred embodiment the electrotechnical fluid composition is used as a transformer oil, having the benefits that it evaporates less than known transformer oils.

One or more examples of the implementations are set forth in more detail in the description below. Other features will be apparent from the description and the claims.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising”, “containing” and “including” should be understood as not limiting the described embodiments to consist of only those features that have been mentioned and such embodiments may contain also features/structures that have not been specifically mentioned.

All standards referred herein are the latest revisions available, unless otherwise mentioned.

The present invention discloses a method for production of an electrotechnical fluid composition, an electrotechnical fluid composition and use of an electrotechnical fluid composition.

More specifically, the present invention discloses a method for production of electrotechnical fluid composition comprising ketonisation and hydrotreatment, such as hydrodeoxygenation and isomerisation, of renewable feedstock to obtain a renewable paraffinic intermediate product, followed by fractionation, preferably by distillation.

In one embodiment, the obtained renewable paraffinic intermediate product is subject to at least one fractionation process to recover a hydrocarbon composition having a boiling range within a range from about 280° C. to about 400° C. (EN ISO3405:2011). This wider range has the benefit that more of the cut is used, i.e. a better yield is achieved.

In one embodiment, the obtained renewable paraffinic intermediate product is subject to at least one fractionation process to recover a hydrocarbon composition having a boiling range within a range from about 280° C. to about 375° C. (EN ISO3405:2011).

In one embodiment, the obtained renewable paraffinic intermediate product is subject to at least one fractionation process to recover a hydrocarbon composition having a boiling range within a range from about 280° C. to about 350° C. (EN ISO3405:2011). This more narrow range has the benefit that the product has even better properties than if the wider distillation temperature range is used.

The present invention also relates to an electrotechnical fluid which fulfils the requirements according to IEC60296(2012), and which electrotechnical composition may be prepared by the method according to the present invention.

The requirements according to IEC60296(2012) are a maximum density at 20° C. of 895 kg/m³, a maximum pour point of −40° C., a maximum kinematic viscosity at 40° C. of 12 mm²/s, a maximum kinematic viscosity at −30° C. of 1800 mm 2/s, a minimum flash point of 135° C., a maximum total sulphur content of 500 mg/kg, a maximum total acidity of 0.3 mg KOH/g, a maximum water content (bulk) of 30 mg/kg and a minimum interfacial tension of 40 nM/m, as also specified in Table 4 of the present application.

In addition, the invention relates to the use of an electrotechnical fluid.

The renewable paraffinic intermediate product may be obtained by ketonisation and hydrotreatment, such as hydrodeoxygenation and isomerisation, of renewable (biosourced) raw material. i.e. renewable feedstock. The renewable feedstock has a carbon number distribution in the range from C4 to C26, mainly including C16 and C18. The renewable paraffinic intermediate product thus obtained has a carbon number distribution in the range from C4 to C51, mainly including C31-C35. The renewable paraffinic intermediate product comprises mainly n-paraffins and i-paraffins.

A distillate obtained after a fractionation process to recover a hydrocarbon composition having a boiling range within a range from about 280° C. to about 400° C. has a carbon number distribution in the range from C15 to C25.

In an embodiment, the renewable paraffinic intermediate product for the separation/fractionation is provided by catalytic ketonisation and catalytic hydrotreatment of the renewable feedstock.

In another embodiment, the hydrotreatment includes catalytic hydrodeoxygenation and hydroisomerisation.

In another embodiment, the separation process comprises fractionation by distillation. The distillation can be continuous or batch-wise.

In one embodiment, the steps of ketonisation and hydrotreatment, such as hydrodeoxygenation and isomerisation, are followed by hydrofinishing.

The boiling range covers a temperature interval from the initial boiling point, IBP, defined as the temperature at which the first drop of distillation product is obtained, to a final boiling point, FBP, when the highest-boiling compounds evaporate.

According to an embodiment, a renewable paraffinic intermediate product obtained may be subject to at least one fractionation to obtain the electrotechnical composition, wherein the fractionation is conducted such that the recovered electrotechnical fluid composition has a boiling range within a range from about 280° C. to about 400° C. (EN ISO3405:2011).

According to an embodiment, a renewable paraffinic intermediate product obtained may be subject to at least one fractionation to obtain the electrotechnical composition, wherein the fractionation is conducted such that the recovered electrotechnical fluid composition has a boiling range within a range from about 280° C. to about 375° C. (EN ISO3405:2011).

According to an embodiment, a renewable paraffinic intermediate product obtained may be subject to at least one fractionation to obtain the electrotechnical fluid composition, wherein the fractionation is conducted such that the recovered electrotechnical fluid composition has a boiling range within a range from about 280° C. to about 350° C. (EN ISO3405:2011).

In one embodiment the at least one fractionation is obtained by distillation.

The electrotechnical composition obtained by the method of the present disclosure fulfils the requirements for such products, according to IEC60296(2012) international standard.

EN ISO 3405:2011 and ASTM D86:2015 standards “Standard Test Method for Distillation of Petroleum Products and Liquid Fuels at Atmospheric Pressure”, as well as ASTM D7345:2017 standard “Standard Test Method for Distillation of Petroleum Products and Liquid Fuels at Atmospheric Pressure (Micro Distillation Method)” describe a distillation method for measuring the boiling point distribution of liquid fuel products having boiling range within a range from 0° C. to 400° C. (ASTM D7345: 20° C. to 400° C.). Using ASTM D86 or ASTM D7345, boiling points are measured at 25 vol-% distilled. The points may also be reported at 88% distilled.

### Description of the Process

By the term “ketonisation” is meant the ketonisation reaction of carboxylic acids and derivatives thereof, particularly fatty acids, corresponding esters, alcohols, aldehydes, and anhydrides. In the reaction the functional groups react with each other yielding ketones. The ketonisation reaction of two carboxylic acids proceeds through an anhydride intermediate to give a ketone, water and carbon dioxide liberating in the reaction. For alcohols and esters, the ketonisation reaction proceeds via aldehydes to give a Tishchenko ester and further to ketones, for aldehydes via Tishchenko esters to ketones. In these two last reactions carbon monoxide is liberated.

By the term “hydrotreatment” is meant a catalytic process of organic material by all means of molecular hydrogen. Preferably, hydrotreatment removes oxygen from organic oxygen compounds as water i.e. by hydrodeoxygenation (HDO). Additionally/alternatively, hydrotreatment may remove sulphur from organic sulphur compounds as dihydrogen sulphide (H₂S), i.e. by hydrodesulphurisation, (HDS), remove nitrogen from organic nitrogen compounds as ammonia (NH₃), i.e. by hydrodenitrofication (HDN), remove halogens, for example chlorine, from organic chloride compounds as hydrochloric acid (HCl), i.e. by hydrodechlorination (HDCI), and/or remove aromatics to obtain an aromate free product, i.e. by hydrodearomatisation (HDA).

By the term “hydrodearomatisation” (HDA) is meant saturation or ring opening of aromatics by the means of molecular hydrogen under the influence of a catalyst.

By the term “hydrodeoxygenation” (HDO) of for example triglycerides or other fatty acid derivatives or fatty acids, is meant the removal of for example carboxyl oxygen as water by means of molecular hydrogen under the influence of a catalyst.

Reaction conditions and catalysts suitable for the hydrodeoxygenation of renewable raw material and the isomerisation of resultant n-paraffins are known. Examples of such processes are presented in FI100248, Examples 1-3, and in WO 2015/101837 A2.

By the term “deoxygenation” is meant removal of oxygen from organic molecules, such as fatty acid derivatives, alcohols, ketones, aldehydes and/or ethers, by any means previously described, or decarboxylation or decarbonylation.

By the term “isomerisation” is meant a process in which a molecule is transformed into another molecule which has exactly the same atoms, but the atoms have a different arrangement. In this context, isomerisation refers both to the isomerisation of paraffins carboxylic acids and alkyl esters thereof, and to hydroisomerisation.

By the term “intermediate product” is meant a composition obtained from the feedstock after at least one process step, such as ketonisation and hydrotreatment, but which is further subjected to an additional process step, such as fractionation to obtain the final product.

In the method of the present invention, the renewable feedstock is subjected to ketonisation and hydrotreatment, preferably to hydrodeoxygenation and isomerisation. In case unsaturated carboxylic acids and/or esters of unsaturated carboxylic acids, preferably fatty acids and/or fatty acid alkyl esters are used as the feedstock, the isomerisation may be performed prior to ketonisation followed by hydrodeoxygenation, otherwise the isomerisation is carried out after the ketonisation and hydrodeoxygenation steps, or even simultaneously.

In one embodiment, the steps of ketonisation, hydrodeoxygenation and isomerisation are followed by a hydrofinishing step.

### Renewable Feedstock

Renewable feedstock (i.e. feedstock of biological origin) refers to a feedstock derived from a biological raw material component containing oils and/or fats, usually containing lipids (e.g. fatty acids or glycerides), such as plant oil/fats, vegetable oil/fats, animal oil/fats, fish oil/fats and algae oil/fats, or oil/fats from other microbial processes, for example, genetically manipulated algae oil/fats, genetically manipulated oil/fats from other microbial processes and also genetically manipulated vegetable oil/fats. Preferably it is waste or residue material. Components or derivatives of such materials may also be used, for example, alkyl esters (typically C1-C5 alkyl esters, such as methyl, ethyl, propyl, isopropyl, butyl, sec-butyl esters) or olefins.

The renewable oils and/or fats may include a single kind of oil, a single kind of fat, mixtures of different oils, mixtures of different fats, mixtures of oil(s) and fat(s), fatty acids, glycerol, and/or mixtures of the afore-mentioned.

These oils and/or fats typically comprise C8-C24 fatty acids and derivatives thereof, including esters of fatty acids, glycerides, i.e. glycerol esters of fatty acids. The glycerides may specifically include monoglycerides, diglycerides and triglycerides.

The ¹⁴C-isotope content can be used as evidence of the renewable or biological origin of a feedstock or product. Carbon atoms of renewable material comprise a higher number of unstable radiocarbon (¹⁴C) atoms compared to carbon atoms of fossil origin. Therefore, it is possible to distinguish between carbon compounds derived from biological sources, and carbon compounds derived from fossil sources by analysing the ratio of ¹²C and ¹⁴C isotopes. Thus, a particular ratio of said isotopes can be used to identify renewable carbon compounds and differentiate those from non-renewable i.e. fossil carbon compounds. The isotope ratio does not change in the course of chemical reactions. Example of a suitable method for analysing the content of carbon from biological sources is ASTM D6866 (2020). An example of how to apply ASTM D6866 to determine the renewable content in fuels is provided in the article of Dijs et al., Radiocarbon, 48(3), 2006, pp 315-323. For the purpose of the present invention, a carbon-containing material, such as a feedstock or product is considered to be of biological i.e. renewable origin if it contains 90% or more modern carbon (pMC), such as 100% modern carbon, as measured using ASTM D6866.

In an embodiment the electrotechnical fluid composition of the present invention has modern carbon content (pMC) of at least 5%, especially at least 60%, such as at least 75%, or even 100%.

### Preparation of Renewable Paraffinic Intermediate Product

Generally, the renewable paraffinic intermediate product may be produced from the renewable feedstock using any known method. Specific examples of a method for producing the renewable paraffinic intermediate product are provided in the European patent application EP 1963461 A1.

In one embodiment, the renewable feedstock comprises fatty acids, or fatty acid derivatives, such as triglycerides, or a combination thereof.

### Ketonisation

The preparation of a renewable paraffinic intermediate product according to the present invention involves ketonisation of the feedstock of renewable raw material. Process conditions for ketonisation are known e.g. in EP 1963461 A1. For example, the ketonisation may be carried out using a metal oxide catalyst. Typical metals include Na, Mg, K, Ca, Sc, Cr, Mn, Fe, Co, Ni, Cu, Zn, Sr, Ti, Y, Zr, Mo, Rh, Cd, Sn, La, Pb, Bi, and rare earth metals. These metal oxides may be on a support, typical supports being laterite, bauxite, titanium dioxide, silica and/or aluminium oxide. The catalyst is preferably a metal oxide catalyst selected from the list consisting of one or more of: Ti, Mn, Mg, Ca, and Zr containing metal oxide catalyst. The ketonisation catalyst more preferably comprises TiO₂. The ketonisation catalyst is most preferably TiO₂, optionally on a support. For example, the catalyst may be TiO₂ in anatase form having an average pore diameter of 80-160 Å, and/or a BET area of 40-140 m²/g, and/or porosity of 0.1-0.3 cm³/g.

The ketonisation may e.g. be performed at a pressure from 0.1 to 5 MPa, preferably from 0.1 to 1 MPa, whereas the temperature may range between 100 and 500° C., preferably between 100 and 400° C., more preferably between 300 and 400° C. The ketonisation may be performed at a feed flow rate WHSV of 0.1 to 10 1/h, preferably 0.3 to 5 1/h, more preferably 0.3 to 3 1/h. The ketonisation reaction may take place in the presence of a gas, such as inert gas like nitrogen, or hydrogen or carbon dioxide. Preferably the gas is selected from one or more of: CO₂, H₂, N₂, CH₄, H₂O. Most preferably it is CO₂. The amount may vary from large excess to small stoikiometric excess. Preferably, the gas flow is in the range from 0.1-1.5 gas/feed ratio (w/w) for cost reasons.

### Hydrotreatment

The ketonisation is followed by hydrotreatment wherein the ketonised feed is subjected to hydrogen in the presence of a catalyst under pressure, preferably at least one catalyst selected from Ni, Mo, Co or W. Typically hydrotreating removes unsaturated bonds, such as double bonds, oxygen (deoxygenation) and other heteroatoms, such as nitrogen, sulfur and chlorine. Hydrotreatment may be performed selectively in several steps using varying catalysts and tailored reaction conditions.

### Hydrodeoxygenation

The ketonisation may be followed by hydrotreatment, preferably comprising hydrodeoxygenation (HDO), where hydrogenation of oxygen bonds takes place, removing oxygen as H₂O. Process conditions for hydrodeoxygenation are known in the art. For example, the hydrodeoxygenation of renewable raw material may be carried out on a metal sulphide catalyst. The metal may be one or more Group VI metals, such as Mo or W, or one or more Group VIII nonnoble metals, such as Co or Ni or mixtures thereof. The catalyst may be supported on any convenient support, such as alumina, silica, zirconia, titania, amorphous carbon, molecular sieves or combinations thereof. Usually the metal is impregnated or deposited on the support as metal oxides. They are then typically converted into their sulphides. Examples of typical catalysts for hydrodeoxygenation are molybdenum containing catalysts, NiMo, CoMo, or NiW catalysts, supported on alumina or silica, but many other hydrodeoxygenation catalysts are known in the art, and have been described together with or compared to NiMo and/or CoMo catalysts. The hydrodeoxygenation is preferably carried out under the influence of sulphided NiMo or sulphided CoMo catalysts in the presence of hydrogen gas.

The hydrodeoxygenation may be performed under a hydrogen pressure from 1 to 15 MPa at temperatures from 150° C. to 400° C., preferably from 200° C. to 400° C., and a WHSV in the range from 0.5-3 1/h. During the hydrodeoxygenation step using a sulfided catalyst, the sulfided state of the catalyst may be maintained by the addition of sulphur in the gas phase or by using a feedstock having sulphur containing mineral oil blended with the renewable feedstock. The sulphur content of the total feed being subjected to hydrodeoxygenation may be, for example, in the range of 50 wppm (ppm by weight) to 20 000 wppm, such as 50, 100, 500, 1000, 1500, 2000, 2500, 3000, 3500, 4000, 4500, 5000, 5500, 6000, 6500, 7000, 7500, 8000, 8500, 9000, 9500, 10 000, 10 500, 11 000, 11 500, 12 000, 12 500, 13 000, 13 500, 14 000, 14 500, 15 000, 15 500, 16 000, 16 500, 17 000, 17 500, 18 000, 18 500, 19000, 19 500 or 20 000 wppm, preferably in the range of 50 wppm to 1000 wppm, more preferably in the range of 50 wppm to 570 wppm.

Effective conditions for hydrodeoxygenation may reduce the oxygen content of the feedstock to less than 1 wt-%, such as less than 0.5 wt-% or less than 0.2 wt-%, such as from 0.2 to 0.05 wt-%, to essentially oxygen free state. In some cases, the conditions may be selected to yield partial hydrodeoxygenation corresponding to a deoxygenation of at least 40 wt-%, at least 50 wt-% or at least 75 wt-%.

In a preferred embodiment, the hydrodeoxygenation reaction conditions comprise one or more of the following: a temperature in the range from 250 to 400° C.; a pressure in the range from 2 to 8 MPa; a WHSV in the range from 0.1 to 10 1/h, preferably from 0.3 to 5 1/h, more preferably from 0.5 to 3 1/h; and a H₂ flow of 350-900 nl H₂/I feed. The hydrodeoxygenation reaction is performed in the presence of a hydrodeoxygenation catalyst, such as Pd, Pt, Ni, NiMo, CoMo or NiW metals, on active carbon, alumina and/or silica supports, preferably NiMo on an alumina support.

### Isomerisation

The renewable paraffinic intermediate product of the present invention may be provided by subjecting at least straight chain hydrocarbons in the raw material that has been subject to ketonisation to an isomerisation treatment to prepare the renewable paraffinic intermediate product.

The isomerisation treatment causes branching of hydrocarbon chains, i.e. isomerisation, of the ketonised and hydrotreated raw material. Branching of hydrocarbon chains improves cold properties, i.e. the isomeric composition formed by the isomerisation treatment has better cold properties compared to the ketonised and hydrotreated raw material.

The isomerisation step may be carried out in the presence of an isomerisation catalyst, and optionally in the presence of hydrogen added to the isomerisation process. Suitable isomerisation catalysts contain a molecular sieve and/or a metal selected from Group VIII of the periodic table and optionally a carrier. Preferably, the isomerisation catalyst contains SAPO-11, or SAPO-41, or ZSM-22, or ZSM-23, or fernerite, and Pt, Pd, or Ni, and Al₂O₃, or SiO₂. Typical isomerisation catalysts are, for example, Pt/SAPO-11/Al₂O₃, Pt/ZSM-22/Al₂O₃, Pt/ZSM-23/Al₂O₃, and Pt/SAPO-11/SiO₂. The catalysts may be used alone or in combination. The presence of added hydrogen is particularly preferable to reduce catalyst deactivation. In a preferred embodiment, the isomerisation catalyst is a noble metal bifunctional catalyst, such as Pt-SAPO and/or Pt-ZSM-catalyst, which is used in combination with hydrogen. The isomerisation step may, for example, be conducted at a temperature of 200-400° C., preferably 280-400° C., and at a pressure of 1-15 MPa, preferably 1-10 MPa. The isomerisation step may comprise further intermediate steps such as a purification step and a fractionation step. The isomerisation may be performed e.g. at 300° C. to 350° C.

In one embodiment, the isomerisation reaction conditions comprise one or more of the following: a temperature in the range from 250 to 400° C.; a pressure in the range from 3 to 6 MPa; a WHSV in the range from 0.5-3 1/h; a H₂ flow of 100-800 nl H₂/I feed. The hydroisomerisation reaction is carried out in the presence of an isomerisation catalyst, such as a catalyst comprising a Group VIII metal and a molecular sieve, optionally on an alumina and/or silica support.

Incidentally, the isomerisation treatment is a step which predominantly serves to isomerise the hydrotreated raw material. That is, while HDO typically results in a minor degree of isomerisation (usually less than 5 wt-%) depending of selected reaction condition, the isomerisation step which may be employed in the present invention is a step which leads to a significant increase in the content of isoparaffins.

The cuts according to the present invention have a pour point below −40° C., and in view of that they must have a very high degree of isomerisation, such as at least 90%, preferably at least 95%. The different processes thus give different products having differences in their carbon chain distribution, branching and properties, even if the same cuts are taken out.

The hydrodeoxygenation step and the isomerisation step may be performed either simultaneously or in sequence. They may be carried out in a single step on the same catalyst bed using a single catalyst for this combined step, e.g. NiW, or a Pt catalyst, such as Pt/SAPO in a mixture with a Mo catalyst on a support, e.g. NiMo on alumina.

### Hydrofinishing Step

After the hydrodeoxygenation and isomerisation steps, the feedstock may be subject to hydrofinishing for removing any remaining double bonds and aromatics, but this step is not mandatory. The hydrofinishing may be carried out using hydrogen in the presence of a catalyst, the pressure ranging from 1 to 20 MPa, preferably from 2 to 15 MPa, and particularly preferably from 3 to 10 MPa. The temperature may range between 50 and 500° C., preferably between 200 and 400° C., and particularly preferably between 200 and 300° C. In the hydrofinishing, special catalysts containing metals of the group VIII of the periodic system of the elements, and a support may be used. The hydrofinishing catalyst is preferably a supported Pd, Pt, or Ni catalyst, the support being alumina and/or silica. Finishing may also be achieved by removing polar components using adsorption materials, such as clay or molecular sieves.

### Fractionation Step

Any known fractionation method, or combination of fractionation methods, may be used in the production of an electrotechnical fluid composition according to the present invention from the renewable paraffinic intermediate product to recover a hydrocarbon composition having a boiling range within a range from about 280° C. to about 400° C. (EN ISO3405:2011), or within a range from about 280° C. to about 350° C. (EN ISO3405:2011).

Preferably the separation is selected so that the carbon number distribution in the fraction with a boiling range of 280-400° C. is such that the distillate comprises 0-4 wt-% C15 paraffins, 18-21 wt-% C16 paraffins, 10-13 wt-% C17 paraffins, 9-11 wt-% C18 paraffins, 8.5-10.5 wt-% C19 paraffins, 8.5-10.5 wt-% C20 paraffins, 8-10 wt-% C21 paraffins, 7.5-9.5 wt-% C22 paraffins, 7-9.5 wt-% C23 paraffins, 6-8 wt-% C24 paraffins and 4.5-6.5 wt-% C25-C29 paraffins.

Preferably the separation is selected so that the carbon number distribution in the fraction with a boiling range of 280-350° C. is such that the distillate comprises 0-5 wt-% C15 paraffins, 27-30 wt-% C16 paraffins, 16.5-19 wt-% C17 paraffins, 15.5-18.5 wt-% C18 paraffins, 15.5-18 wt-% C19 paraffins, 11.5-14.5 wt-% C20 paraffins, 2.5-5.5 wt-% C21 paraffins, and 0.1-2 wt-% C22 paraffins.

The carbon number distributions as specified above do not exclude that other carbon numbers are present, but these are preferably only present at amounts of less than 0.3 wt % for each carbon number.

Preferably the separation is selected so that a majority of the i-paraffins end up in the recovered distilled fraction.

In one embodiment an electrotechnical fluid composition is produced by subjecting the renewable paraffinic intermediate product to at least one separation process comprising distillation.

In one embodiment the initial boiling point, IBP, is 280° C. and the final boiling point, FBP, is 400° C. (EN-ISO3405:2011).

In one embodiment the initial boiling point, IBP, is 280° C. and the final boiling point, FBP, is 375° C. (EN-ISO3405:2011).

In one embodiment the initial boiling point, IBP, is 280° C. and the final boiling point, FBP, is 350° C. (EN-ISO3405:2011).

In one embodiment the process comprises two or more separation steps.

Selection of renewable feedstock regarding favourable characteristics, such as selecting a renewable feedstock having a high amount of compounds having carbon chain length peaking at C16 and C18, may be used to increase the yield of the products, including electrotechnical fluid composition and renewable base oil.

The yield of electrotechnical fluid composition may be increased also by the selection of the process conditions in the renewable paraffinic intermediate product production process.

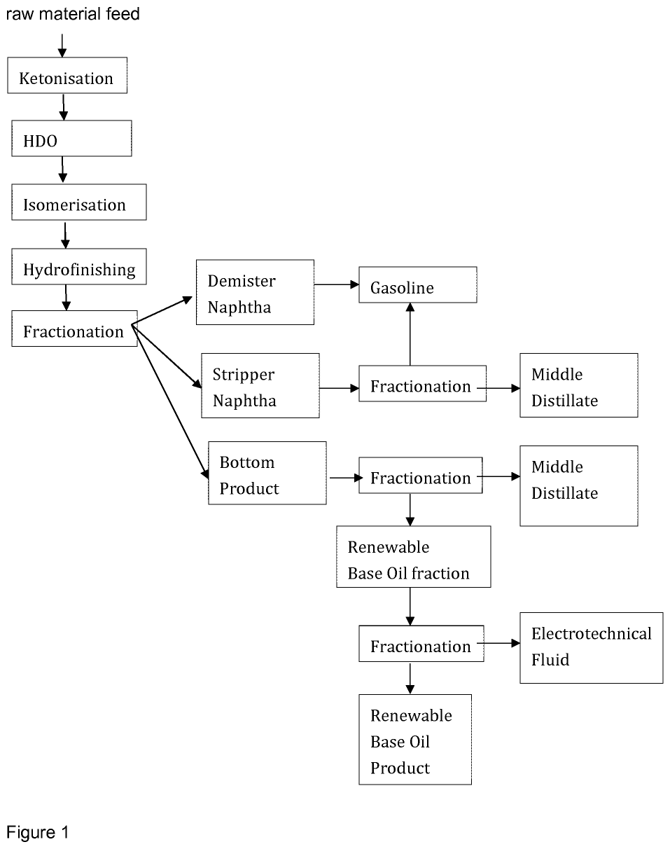

In one embodiment of the present invention according to FIG. 1, the raw material comprising free fatty acids and glycerols is subject to ketonisation under ketonisation conditions, followed by hydrodeoxygenation under hydrodeoxygenation conditions. The ketonised and hydrodeoxygenated raw material is then subject to isomerisation, followed by an optional step of hydrofinishing. The product is then subject to initial fractionation e.g. by distillation or stripper, where it is fractionated into demister naphtha, stripper naphtha and bottom product. The stripper naphtha is subjected to further fractionation, resulting in middle distillates, such as diesel fraction, and gasoline, which is used together with the gasoline obtained from the demister naphtha. The bottom product is further fractionated into middle distillate, such as diesel, and renewable base oil fraction. The renewable base oil fraction is yet further fractionated, and the distillation cuts 280-400° C. or 280-350° C. are collected and evaluated in terms of performance as electrotechnical fluid composition. The heavier cut includes the renewable base oil product.

In one embodiment the present invention relates to a method for producing an electrotechnical fluid composition, comprising subjecting a renewable feedstock comprising free fatty acids and glycerides to ketonisation under ketonisation conditions, subjecting the ketonised renewable feedstock to hydrotreatment under hydrotreatment conditions, to obtain a renewable paraffinic intermediate product, subjecting the renewable paraffinic intermediate product to at least one fractionation to obtain the electrotechnical fluid composition, wherein the electrotechnical fluid composition fulfils the requirements according to IEC60296(2012) international standard.

In one embodiment the electrotechnical fluid composition has a density at 20° C. of equal to or less than 895 kg/m³, preferably less than 800 kg/m3.

In one embodiment the electrotechnical fluid composition has a pour point of less than −40° C. (ISO 3016).

In one embodiment the electrotechnical fluid composition has a kinematic viscosity at 40° C. of equal to or less than 12 mm²/s, preferably less than 10 mm²/s, more preferably less than 8 mm²/s, such as less than 6 mm²/s.

In one embodiment the electrotechnical fluid composition has a kinematic viscosity at −30° C. of equal to or less than 1800 mm²/s, preferably less than 150 mm²/s, such as less than 120 mm²/s.

In one embodiment the electrotechnical fluid composition has a flash point of equal to or more than 135° C.

In one embodiment the electrotechnical fluid composition has a total acidity of equal to or less than 0.01 mg KOH/g, such as less than 0.005 mg KOH/g.

In one embodiment the electrotechnical fluid composition has a water content of equal to or less than 30 mg/kg, preferably less than 20 mg/kg.

In one embodiment said at least one fractionation is conducted in such a way that the recovered electrotechnical composition has a boiling range within a range from about 280° C. to about 400° C., preferably within a range from about 280° C. to about 400° C. (EN ISO3405:2011), more preferably within a range from about 280° C. to about 350° C. (EN ISO3405:2011).

In one embodiment said at least one fractionation is provided by distillation.

In one embodiment said at least one fractionation is provided by fractionation distillation.

In one embodiment the ketonisation is conducted at a temperature range between 100 and 500° C., preferably between 100 and 400° C., more preferably between 300 and 400° C.

In one embodiment the ketonisation is conducted at a pressure of from 0.1 to 5 MPa, preferably from 0.1 to 1 MPa.

In one embodiment the ketonisation is conducted at a feed flow rate WHSV of 0.1 to 10 I/h, preferably 0.3 to 5 I/h, more preferably 0.3 to 3 I/h.

In one embodiment the ketonisation is conducted in the presence of at least one metal oxide ketonisation catalyst.

In one embodiment the metal oxide ketonisation catalyst comprises Ti, more preferably TiO₂, even more preferably wherein the catalyst consists of TiO₂.

In one embodiment said ketonisation conditions comprise a temperature from 100 to 400° C., a pressure from 0.1 to 5 MPa, and the presence of a metal oxide ketonisation catalyst, wherein the ketonisation catalyst preferably comprises TiO₂.

In one embodiment said hydrotreatment conditions comprise the presence of hydrogen gas and at least one catalyst selected from Ni, Mo, Co or W.

In one embodiment said hydrotreatment comprises hydrodeoxygenation under hydrodeoxygenation conditions, and isomerisation under isomerisation conditions, simultaneously or in sequence.

In one embodiment the hydrodeoxygenation is conducted at a temperature range between 150 and 400° C., preferably between 200 and 400° C.

In one embodiment the hydrodeoxygenation is conducted at a pressure of from 1 to 15 MPa, preferably 2 to 8 MPa.

In one embodiment the hydrodeoxygenation is conducted at a feed flow rate WHSV of 0.1 to 10 1/h, preferably 0.3 to 5 1/h, more preferably 0.5 to 3 1/h.

In one embodiment the hydrodeoxygenation is conducted at a H₂ flow of 350-900 nl H₂/I feed.

In one embodiment the hydrodeoxygenation is conducted in the presence of at least one hydrodeoxygenation catalyst.

In one embodiment the hydrodeoxygenation catalyst comprises at least one metal selected from the group consisting of Pd, Pt, Ni, CoMo, NiMo, NiW and CoNiMo.

In one embodiment the catalyst may be supported on a support, selected from the group consisting of alumina, silica, zirconia, titania, amorphous carbon, molecular sieves, or combinations thereof.

In one embodiment said hydrodeoxygenation conditions comprise a hydrogen pressure ranging from 1 to 15 MPa at a temperature ranging from 150 to 400° C., and the presence of a catalyst containing Pd, Pt, Ni, NiMo, CoMo or NiW metals, and active carbon, alumina and/or silica supports.

In one embodiment said isomerisation conditions comprise a temperature range between 200 and 400° C., preferably between 250 and 400° C., more preferably between 280 and 400° C.

In one embodiment said isomerisation conditions comprise a pressure of from 1 to 15 MPa, preferably 1 to 10 MPa.

In one embodiment said isomerisation conditions comprise a feed flow rate WHSV of 0.5 to 3 1/h.

In one embodiment said isomerisation conditions comprise a H₂ flow of 100-800 nl H₂/I feed.

In one embodiment said isomerisation conditions comprise the presence of a hydroisomerisation catalyst.

In one embodiment the hydroisomerisation catalyst is selected from a group VIII metal, preferably Pd, Pt or Ni, optionally on an alumina and/or silica support.

In one embodiment said isomerisation conditions comprise a hydrogen pressure ranging from 1 to 15 MPa at a temperature ranging from 200 to 400° C. and the presence of a catalyst selected from a molecular sieve, and a Pd, Pt or Ni metal, and/or a support, said support being alumina and/or silica.

In one embodiment the method further comprises subjecting the renewable paraffinic intermediate product to a second or further, such as third, fractionation to obtain renewable base oil product fulfilling the API Group III base oil specifications, having >90 wt % saturated hydrocarbons, <0.03 wt % sulfur and a viscosity index of >120.

In one embodiment the present invention relates to an electrotechnical fluid composition or to an electrotechnical fluid composition obtained by a method according to the present invention. These electrotechnical fluid compositions comprise more than 95 wt-%, preferably more than 97 wt-%, even more preferably more than 99 wt-%, paraffins in the C15-C29 range, preferably in the C15-C25 range, based on the total weight of the composition, and wherein the electrotechnical compositions fulfil the requirements according to IEC60296.

The following embodiments apply to both the electrotechnical fluid composition and to the electrotechnical fluid composition obtained by a method according to the present invention.

In one embodiment the electrotechnical fluid composition has a density at 20° C. of equal to or less than 895 kg/m³, preferably less than 800 kg/m3.

In one embodiment the electrotechnical fluid composition has a pour point of less than −40° C. (ISO 3016).

In one embodiment the electrotechnical fluid composition has a kinematic viscosity at 40° C. of equal to or less than 12 mm²/s, preferably less than 10 mm²/s, more preferably less than 8 mm²/s.

In one embodiment the electrotechnical fluid composition has a kinematic viscosity at −30° C. of equal to or less than 1800 mm²/s, preferably less than 150 mm²/s.

In one embodiment the electrotechnical fluid composition has a flash point of equal to or more than 135° C.

In one embodiment the electrotechnical fluid composition has a total acidity of equal to or less than 0.01 mg KOH/g.

In one embodiment the electrotechnical fluid composition has a water content of equal to or less than 30 mg/kg, preferably less than 20 mg/kg.

In one embodiment the electrotechnical composition comprises more than 0.01 wt-%, preferably more than 2.5 wt-%, but up to 5 wt-%, C15 paraffins, based on the total weight of the composition.

In one embodiment the electrotechnical composition comprises more than 5 wt-%, preferably more than 18 wt-%, even more preferably more than 20 wt-%, more preferably than 25 wt-%, such as more than 28 wt-%, but up to wt-%, C16 paraffins, based on the total weight of the composition.

In one embodiment the electrotechnical composition comprises more than 5 wt-%, preferably more than 10 wt-%, preferably more than 15 wt-%, more preferably more than 17 wt-%, but up to 24 wt-%, C17 paraffins, based on the total weight of the composition.

In one embodiment the electrotechnical composition comprises more than 5 wt-%, preferably more than 8 wt-%, preferably more than 15 wt-%, more preferably more than 16 wt-%, but up to 23 wt-%, C18 paraffins, based on the total weight of the composition.

In one embodiment the electrotechnical composition comprises more than 5 wt-%, preferably more than 8 wt-%, preferably more than 15 wt-%, more preferably more than 16 wt-%, but up to 23 wt-%, C19 paraffins based on the total weight of the composition.

In one embodiment the electrotechnical composition comprises more than 5 wt-%, preferably more than 8 wt-%, preferably more than 9 wt-%, more preferably more than 12 wt-%, but up to 19 wt-%, C20 paraffins based on the total weight of the composition.

In one embodiment the electrotechnical composition comprises less than 12 wt-%, preferably less than 10 wt-%, preferably less than 9 wt-%, more preferably less than 5 wt-%, but at least 1 wt-%, C21 paraffins based on the total weight of the composition.

In one embodiment the electrotechnical composition comprises less than 12 wt-%, preferably less than 10 wt-%, preferably less than 9 wt-%, more preferably less than 1 wt-%, but at least 0.1 wt-%, C22 paraffins based on the total weight of the composition.

In one embodiment the electrotechnical composition comprises less than 14 wt-%, preferably less than 10 wt-%, preferably less than 9 wt-%, more preferably less than 1 wt-%, even more preferably less than 0.25 wt-%, but at least 0.05 wt-%, C23 paraffins based on the total weight of the composition.

In one embodiment the electrotechnical composition comprises less than 8 wt-%, preferably less than 7 wt-%, more preferably less than 0.5 wt-%, even more preferably less than 0.1 wt-%, C24 paraffins based on the total weight of the composition.

In one embodiment the total isoparaffinic content of the electrotechnical fluid composition is more than 93 wt-% but less than 99 wt-%, preferably more than 94 wt-% but less than 98 wt-%, more preferably more than 95 wt-% but less than 97 wt-%, based on the total weight of the composition.

In one embodiment the weight ratio of the amount of i-paraffins to the amount of n-paraffins is more than 20, based on the total weight of the composition.

In one embodiment the weight ratio of the amount of i-paraffins to the amount of n-paraffins is less than 32, based on the total weight of the composition.

In one embodiment the electrotechnical fluid has a kinematic viscosity at 40° C. as measured according to ENISO 3104 of 12 mm²/s or below, typically between 3 and 4.5 mm²/s, kinematic viscosity at −30° C. as measured according to ENISO 3104 of equal to or less than 1800 mm²/s, typically below 120 mm²/s, flash point (PM) as measured according to ENISO 2719 of equal to or more than 135° C., typically at least 137° C., and acidity of equal to or less than 0.3 mg KOH/g, typically below 0.009 mg KOH/g.

In one embodiment the electrotechnical fluid has a kinematic viscosity at 40° C. as measured according to ENISO 3104 of 12 mm²/s or below, typically between 4 and 8 mm²/s, kinematic viscosity at −30° C. as measured according to ENISO 3104 of 1800 mm²/s or below, typically below 500 mm²/s, flash point (PM) as measured according to ENISO 2719 of at least 135° C., typically at least 135° C., and acidity of equal to or less than 0.3 mg KOH/g, typically 0.002 mg KOH/g.

In one embodiment the electrotechnical composition has a carbon number range up to C29.

In one embodiment the electrotechnical composition has a carbon number range up to C25.

In one embodiment the electrotechnical composition has a carbon number range down to C15.

In one embodiment the present invention relates to a use of an electrotechnical fluid composition according to the present invention in a transformer, preferably a power transformer.

In one embodiment the present invention relates to a use of an electrotechnical fluid composition according to the present invention as a transformer oil or as a component of transformer oil, battery coolant, heat transfer fluid, coolant, insulating oil, chock absorbing fluid or a cable oil.

In one embodiment the present invention relates to a use of an electrotechnical fluid composition according to the present invention as an electric vehicle battery coolant.

In one embodiment the present invention relates to a use of an electrotechnical fluid composition according to the present invention as a server farm coolant.

In one embodiment the present invention relates to an electrotechnical fluid composition comprising more than 95 wt-%, preferably more than 97 wt-%, even more preferably more than 99 wt-%, paraffins in the C15-C29 range, preferably in the C15-C25 range, based on the total weight of the composition, and wherein the electrotechnical composition fulfils the requirements according to IEC60296.

### Example 1 (Comparative)

Table 1 summarizes physical and chemical properties for the composition of Example 1, NRI-A (Comparative).

Table 2 summarizes carbon number distribution for the composition of Example 1, NRI-A.

The sample composition of Example 1 was produced by hydrodeoxygenation and isomerisation of feedstock of renewable origin as explained above. No ketonisation was conducted before the hydrodeoxygenation. The isomerisation step was followed by a distillation step to recover a hydrocarbon composition having an initial boiling point (IBP) 275° C. and a final boiling point (FBP) 300° C.

The carbon number distribution of the composition of Example 1 is presented in table 2. The composition of Example 1 shows a very narrow carbon number distribution, where C15 paraffins constitute 0.02 wt-% of the composition, C16 paraffins constitute 2.31 wt-% of the composition, C17 paraffins constitute 24.97 wt-% of the composition, C18 paraffins constitute 70.65 wt-% of the composition, C19 paraffins constitute 1.59 wt-% of the composition, C20 paraffins constitute 0.45 wt-% of the composition, and C21 paraffins constitute 0.01 wt-% of the composition. 99.97 wt-% of all paraffins are in the C16-C20 range.

TABLE 1
Physical and chemical properties for comparative composition NRI-A

| | | | | NRI-A |
|---|---|---|---|---|
| | | IEC60296 | | distill. |
| Properties | Method | min | max | 275-300° C. |

| | | | | |
|---|---|---|---|---|
| Density at 20° C. | kg/m³ | | 895 | 783 |
| Cloud point | ° C. | | | −33 |
| Pour point | ° C. | | −40 | below −66 |
| Kinematic Viscosity at 40° C. | mm²/s | | 12 | 3.7 |
| Kinematic Viscosity at −30° C. | mm²/s | | 1800 | |
| Flash point | ° C. | 135 | | 145 |
| Total Sulphur Content | mg/kg | | 500 | |
| Total Acidity | mg KOH/g | | 0.3 | <0.01 |
| Water Content (bulk) | mg/kg | | 30 | 21 |
| Interfacial tension | nM/m | 40 | | 50 |
| Noack at 100° C./150° C./200° C. | wt-% | | | 1/8/59 |

TABLE 2
Carbon number distribution for comparative composition NRI-A

| Carbon | | | Total |
|---|---|---|---|
| number | i-paraffins | n-paraffins | paraffins |
| 3 | 0.00 | 0.00 | 0.00 |
| 4 | 0.00 | 0.00 | 0.00 |
| 5 | 0.00 | 0.00 | 0.00 |
| 6 | 0.00 | 0.00 | 0.00 |
| 7 | 0.00 | 0.00 | 0.00 |
| 8 | 0.00 | 0.00 | 0.00 |
| 9 | 0.00 | 0.00 | 0.00 |
| 10 | 0.00 | 0.00 | 0.00 |
| 11 | 0.00 | 0.00 | 0.00 |
| 12 | 0.00 | 0.00 | 0.00 |
| 13 | 0.00 | 0.00 | 0.00 |
| 14 | 0.01 | 0.00 | 0.02 |
| 15 | 0.22 | 0.08 | 0.29 |
| 16 | 3.66 | 0.42 | 4.08 |
| 17 | 37.42 | 1.51 | 38.93 |
| 18 | 53.27 | 1.17 | 54.44 |
| 19 | 1.58 | 0.04 | 1.63 |
| 20 | 0.45 | 0.03 | 0.48 |
| 21 | 0.10 | 0.00 | 0.10 |
| 22 | 0.03 | 0.00 | 0.04 |
| 23 | 0.00 | 0.00 | 0.00 |
| 24 | 0.00 | 0.00 | 0.00 |
| 25-29 | 0.00 | 0.00 | 0.00 |
| 30-36 | 0.00 | 0.00 | 0.00 |
| >C36 | 0.00 | 0.00 | 0.00 |
| Total | 96.75 | 3.25 | 100.00 |
| paraffins | | | |

### Example 2 (Comparative)

Table 3 summarizes physical and chemical properties of the compositions of three commercially available products, commercial sample A, commercial sample B, and Neste NRI-B (Comparative).

TABLE 3
Physical and chemical properties for commercial
sample A, commercial sample B, and Neste NRI-B

| | | IEC60296 | | Commercial | Commercial | Neste |
|---|---|---|---|---|---|---|
| Properties | | min | max | sample A | sample B | NRI-B |
| Density at 20° C. | kg/m³ | | 895 | 805 | 874 | 874 |
| Pour point | ° C. | | −40 | −42 | −63 | −63 |
| Kinematic Viscosity | mm²/s | | 12 | 9.9 | 7.7 | 7.6 |
| at 40° C. | | | | | | |
| Kinematic Viscosity | mm²/s | | 1800 | 523 | 730 | 730 |
| at −30° C. | | | | | | |
| Flash point | ° C. | 135 | | 191 | | 142 |
| Total Sulphur Content | mg/kg | | 500 | 1 | <0.01 | |
| Total Acidity | mg | | 0.3 | 0.002 | 0.05 | |
| | KOH/g | | | | | |
| Water Content (bulk) | mg/kg | | 30 | 8 | <20 | <20 |
| Interfacial tension | nM/m | 40 | | | 49 | 49 |
| Aromatics | wt % | | | | 6 | |

### Example 3

### The RBO Process

Palm oil fatty acid distillate (PFAD) was used as feedstock for the ketonisation stage. The fractionated feed used consisted mainly of C16:0 fatty acids. Ketonisation was performed in a pilot continuously operated fixed bed reactor system operated at 350° C. under 1.8 MPa pressure using a TiO₂ catalyst in a CO₂ atmosphere (650 I/h). The feed rate was 2.2 kg/h with a gas ratio 0.6 g/g and WHSV of 1.1 1/h. The formed gas was separated from the liquid ketone product, which was directed to a continuous fixed bed HDO reactor including NiMo catalyst. The hydrodeoxygenation was performed to the ketone product, containing mainly C31 ketone, at 309° C. temperature under 6.0 MPa pressure in hydrogen (1270 I/h) wherein the feed rate was 1.4 kg/h and gas ratio 712 NI/I. The obtained paraffinic liquid HDO product was further directed to hydroisomerisation and hydrofinishing. The hydroisomerisation reactor was operated at 340° C. under 4.5 MPa pressure using a commercial hydroisomerisation catalyst and WHSV of 0.9 1/h and gas (hydrogen) to feed ratio of 674 NI/I. The temperature of the hydrofinishing reactor was 285° C. in the same pressure, and WHSV 3.0 1/h.

### Retrieval of Electrotechnical Fluids

The renewable paraffinic branched intermediate product from the RBO process was fractionated by distillation into demister naphtha, naphtha, diesel, electrotechnical fluid component and renewable base oil component. Two different electrotechnical fluid components were collected; one with a distillation cut at 280-400° C. and one with a distillation cut at 280-350° C. These cuts were evaluated in view of their properties and suitability for electrotechnical use.

The evaluation of the properties of the two fractionated cuts showed that the distillation cuts were well suited for use as electotechnical compositions.

Table 4 summarizes physical and chemical properties of the two electrotechnical compositions of Example 3, with a distillation cut at 280-400° C. or 280-350° C.

Table 5 summarizes the carbon number distribution of the composition with a distillation cut at 280-400° C. and Table 6 summarizes the carbon number distribution of the composition with a distillation cut at 280-350° C.

TABLE 4
Physical and chemical properties for electrotechnical compositions with
distillation cut at 280-350° C. and 280-400° C.

| | | | | 14561548 | 14484053 |
|---|---|---|---|---|---|
| | | IEC60296 | | RBO distillate | RBO distillate |
| Properties | | min | max | 280-350° C. | 280-400° C. |
| Density at 20° C. | kg/m³ | | 895 | 788 | 794 |
| Cloud point | ° C. | | | −31 | −27 |
| Pour point | ° C. | | −40 | −42 | −45 |
| Kinematic Viscosity | mm²/s | | 12 | 3.8 | 5 |
| at 40° C. | | | | | |
| Kinematic Viscosity | mm²/s | | 1800 | 55 | 116 |
| at −30° C. | | | | | |
| Flash point | ° C. | 135 | | 139 | 144 |
| Total Sulphur Content | mg/kg | | 500 | N/A | <1 |
| Total Acidity | mg | | 0.3 | 0.001 | 0.002 |
| | KOH/g | | | | |
| Water Content (bulk) | mg/kg | | 30 | <10 | 17 |
| Interfacial tension | nM/m | 40 | | 48 | 40 |
| Noack at 100° C./ | wt % | | | 1/11/61 | 1.5/7/41 |
| 150° C./200° C. | | | | | |
| n-paraffins | wt % | | | 4.32 | 3.21 |
| iso-paraffins | wt % | | | 95.68 | 96.79 |
| Naphthenes | wt % | | | 0 | 0 |
| Aromatics | wt % | | | 0 | 0 |

TABLE 5
Carbon number distribution of the electrotechnical
composition with a distillation cut at 280-400° C.

| | Sum of wt-% | | |
|---|---|---|---|
| | Isomer | | |
| Carbon number | iP | nP | Grand Total |
| 3 | 0.00 | 0.00 | 0.00 |
| 4 | 0.00 | 0.00 | 0.00 |
| 5 | 0.00 | 0.00 | 0.00 |
| 6 | 0.00 | 0.00 | 0.00 |
| 7 | 0.01 | 0.00 | 0.01 |
| 8 | 0.02 | 0.00 | 0.02 |
| 9 | 0.02 | 0.00 | 0.02 |
| 10 | 0.01 | 0.00 | 0.01 |
| 11 | 0.01 | 0.00 | 0.01 |
| 12 | 0.03 | 0.00 | 0.03 |
| 13 | 0.03 | 0.00 | 0.03 |
| 14 | 0.06 | 0.01 | 0.07 |
| 15 | 1.71 | 0.45 | 2.15 |
| 16 | 17.99 | 1.44 | 19.43 |
| 17 | 11.02 | 0.38 | 11.39 |
| 18 | 9.72 | 0.13 | 9.85 |
| 19 | 9.28 | 0.10 | 9.38 |
| 20 | 9.48 | 0.07 | 9.55 |
| 21 | 8.81 | 0.18 | 8.99 |
| 22 | 8.40 | 0.15 | 8.55 |
| 23 | 8.03 | 0.19 | 8.22 |
| 24 | 6.87 | 0.10 | 6.97 |
| 25-29 | 5.30 | 0.00 | 5.30 |
| 30-36 | 0.01 | 0.00 | 0.01 |
| >C36 | 0.00 | 0.00 | 0.00 |
| Grand Total | 96.79 | 3.21 | 100.00 |

TABLE 6
Carbon number distribution of the composition
with a distillation cut at 280-350° C.

| | Sum of wt-% | | |
|---|---|---|---|
| | Isomer | | |
| Carbon number | iP | nP | Grand Total |
| 3 | 0.00 | 0.00 | 0.00 |
| 4 | 0.00 | 0.00 | 0.00 |
| 5 | 0.00 | 0.00 | 0.00 |
| 6 | 0.00 | 0.00 | 0.00 |
| 7 | 0.00 | 0.00 | 0.00 |
| 8 | 0.00 | 0.00 | 0.00 |
| 9 | 0.00 | 0.00 | 0.00 |
| 10 | 0.00 | 0.00 | 0.00 |
| 11 | 0.00 | 0.00 | 0.00 |
| 12 | 0.00 | 0.00 | 0.00 |
| 13 | 0.00 | 0.00 | 0.00 |
| 14 | 0.00 | 0.00 | 0.00 |
| 15 | 2.30 | 0.61 | 2.91 |
| 16 | 26.24 | 2.20 | 28.44 |
| 17 | 17.04 | 0.73 | 17.77 |
| 18 | 16.79 | 0.13 | 16.93 |
| 19 | 16.01 | 0.30 | 16.31 |
| 20 | 12.71 | 0.28 | 12.99 |
| 21 | 3.92 | 0.06 | 3.98 |
| 22 | 0.58 | 0.01 | 0.59 |
| 23 | 0.08 | 0.00 | 0.08 |
| 24 | 0.01 | 0.00 | 0.01 |
| 25-29 | 0.00 | 0.00 | 0.00 |
| 30-36 | 0.00 | 0.00 | 0.00 |
| >C36 | 0.00 | 0.00 | 0.00 |
| Grand Total | 95.68 | 4.32 | 100.00 |

For the distillation cut at 280-400° C., 99.78 wt-% of all the paraffins were in the C15-C29 range. Improvements compared to e.g. the electrotechnical composition of Example 1, i.e. NRI-A, could e.g. be seen in terms of a higher degree of isomerisation in the products obtained when using a method according to the present invention (4.59% normal paraffins for NRI-A of Example 1, compared to 3.21% normal paraffins in the cut of 280-400° C. according to the present invention).

For both the distillation cut at 280-400° C. and at 280-350° C. it was seen that higher molecular weight components could be obtained in the electrotechnical composition according to the present invention, i.e. even up to C25-C29, compared to the composition of Example 1 where no ketonisation takes place in the production method, where the higher molecular weight components of the product end at C20.

The ratio of the amount of C15 i-paraffins to the amount of C15 n-paraffins was 3.8 based on the weight of the C15 i-paraffins and the weight of the C15 n-paraffins in the composition. The ratio of the amount of C16 i-paraffins to the amount of C16 n-paraffins was 12.5 based on the weight of the C16 i-paraffins and the weight of the C16 n-paraffins in the composition. The ratio of the amount of C17 i-paraffins to the amount of C17 n-paraffins was 29.0 based on the weight of the C17 i-paraffins and the weight of the C17 n-paraffins in the composition. The ratio of the amount of C18 i-paraffins to the amount of C18 n-paraffins was 74.8 based on the weight of the C18 i-paraffins and the weight of the C18 n-paraffins in the composition. The ratio of the amount of C19 i-paraffins to the amount of C19 n-paraffins was 92.8 based on the weight of the C19 i-paraffins and the weight of the C19 n-paraffins in the composition. The ratio of the amount of C20 i-paraffins to the amount of C20 n-paraffins was 135.4 based on the weight of the C20 i-paraffins and the weight of the C20 n-paraffins in the composition. The ratio of the amount of C21 i-paraffins to the amount of C21 n-paraffins was 48.9 based on the weight of the C21 i-paraffins and the weight of the C21 n-paraffins in the composition. The ratio of the amount of C22 i-paraffins to the amount of C22 n-paraffins was 56.0 based on the weight of the C22 i-paraffins and the weight of the C22 n-paraffins in the composition. The ratio of the amount of C23 i-paraffins to the amount of C23 n-paraffins was 42.3 based on the weight of the C23 i-paraffins and the weight of the C23 n-paraffins in the composition. The ratio of the amount of C24 i-paraffins to the amount of C24 n-paraffins was 68.7 based on the weight of the C24 i-paraffins and the weight of the C24 n-paraffins in the composition.

For the distillation cut at 280-350° C., 100 wt-% of all the paraffins were in the C15-C29 range, and 99.92 wt-% of all the paraffins were in the C15-C22 range. The ratio of the amount of C15 i-paraffins to the amount of C15 n-paraffins was 3.8 based on the weight of the C15 i-paraffins and the weight of the C15 n-paraffins in the composition. The ratio of the amount of C16 i-paraffins to the amount of C16 n-paraffins was 11.9 based on the weight of the C16 i-paraffins and the weight of the C16 n-paraffins in the composition. The ratio of the amount of C17 i-paraffins to the amount of C17 n-paraffins was 23.3 based on the weight of the C17 i-paraffins and the weight of the C17 n-paraffins in the composition. The ratio of the amount of C18 i-paraffins to the amount of C18 n-paraffins was 129.2 based on the weight of the C18 i-paraffins and the weight of the C18 n-paraffins in the composition. The ratio of the amount of C19 i-paraffins to the amount of C19 n-paraffins was 53.4 based on the weight of the C19 i-paraffins and the weight of the C19 n-paraffins in the composition. The ratio of the amount of C20 i-paraffins to the amount of C20 n-paraffins was 45.4 based on the weight of the C20 i-paraffins and the weight of the C20 n-paraffins in the composition. The ratio of the amount of C21 i-paraffins to the amount of C21 n-paraffins was 65.3 based on the weight of the C21 i-paraffins and the weight of the C21 n-paraffins in the composition. The ratio of the amount of C22 i-paraffins to the amount of C22 n-paraffins was 58.0 based on the weight of the C22 i-paraffins and the weight of the C22 n-paraffins in the composition.

As is seen from the tables, the fractions with distillation cuts at 280-350° C. and 280-400° C. were evaluated in terms of transformer oil performance with good results. The results for both fractions cuts were shown to be in line with the standard requirements. The fraction of 280-350° C. had a lower viscosity, lower cloud point and higher interfacial tension than the fraction of 280-400° C.

The content of aromatics for the fraction 280-350° C. was measured according to UOP495 and was as low as 0.001 wt-%, based on the total weight of the composition. Such a low amount is beneficial for safety and toxicity issues, and is a great benefit compared to other electrotechnical compositions having a greater content of aromatics. Further, the content of naphtalenes was measured according to UOP495 for the fraction 280-350° C., and was <0.001, i.e. a low value that is beneficial since naphtalenes are carcinogens.

It will be obvious to a person skilled in the art, as the technology advances, that the inventive concept of the present invention can be implemented in various ways. The invention and its embodiments are not limited to the examples described above but may vary within the scope of the claims.

1. A method for producing an electrotechnical fluid composition, comprising:
a) subjecting a renewable feedstock including free fatty acids and glycerides to ketonisation under ketonisation conditions;
b) subjecting the ketonised renewable feedstock to hydrotreatment under hydrotreatment conditions, to obtain a renewable paraffinic intermediate product; and
c) subjecting the renewable paraffinic intermediate product to at least one fractionation to obtain the electrotechnical fluid composition;
wherein the electrotechnical fluid composition fulfils the requirements according to IEC60296(2012) international standard.

2. The method according to claim 1, comprising:
conducting said at least one fractionation in such a way that the electrotechnical fluid composition has a boiling range within a range from 280° C. to 400° C. (EN ISO3405:2011).

3. The method according to claim 1, wherein said at least one fractionation is provided by distillation.

4. The method according to claim 1, wherein said ketonisation conditions comprise:
a temperature from 100 to 500° C., a pressure from 0.1 to 5 MPa, and a presence of a metal oxide ketonisation catalyst, and/or wherein the ketonisation catalyst includes TiO₂.

5. The method according to claim 1, wherein said hydrotreatment conditions comprise:
a presence of hydrogen gas and at least one catalyst selected from Ni, Mo, Co or W.

6. The method according to claim 1, wherein said hydrotreatment comprises:
hydrodeoxygenation under hydrodeoxygenation conditions, and isomerisation under isomerisation conditions, simultaneously or in sequence.

7. The method according to claim 6, wherein said hydrodeoxygenation conditions comprise:
a hydrogen pressure ranging from 1 to 15 MPa at a temperature ranging from 150 to 400° C., and a presence of a catalyst containing Pd, Pt, Ni, NiMo, CoMo or NiW metals, and active carbon, alumina and/or silica supports.

8. The method according to claim 6, wherein said isomerisation conditions comprise:
a hydrogen pressure ranging from 1 to 15 MPa at a temperature ranging from 200 to 400° C., and a presence of a catalyst selected from a molecular sieve, and a Pd, Pt or Ni metal, and/or a support, said support being alumina and/or silica.

9. The method according to claim 1, comprising:
subjecting the renewable paraffinic intermediate product to at least one fractionation to further obtain renewable base oil product fulfilling API Group III base oil specifications, having >90 wt % saturated hydrocarbons, <0.03 wt % sulfur and a viscosity index of >120.

10. An electrotechnical fluid composition obtained by a method as claimed in claim 1, comprising,
more than 95 wt-%, and/or more than 97 wt-%, and/or more than 99 wt-%, paraffins in a C15-C29 range, and/or in a C15-C25 range, based on a total weight of the composition, and wherein the electrotechnical fluid composition fulfils a requirements according to IEC60296(2012).

11. The electrotechnical fluid composition according to claim wherein the electrotechnical fluid composition has a density at 20° C. of equal to or less than 895 kg/m³, and/or less than 800 kg/m³.

12. The electrotechnical fluid composition according to claim 10, wherein the electrotechnical fluid composition has a pour point of less than −40° C. (ISO 3016).

13. The electrotechnical fluid composition according to claim 10, wherein the electrotechnical fluid composition has a kinematic viscosity at 40° C. of equal to or less than 12 mm²/s, and/or less than 10 mm²/s, and/or less than 8 mm²/s.

14. The electrotechnical fluid composition according to claim 10, wherein the electrotechnical fluid composition has a kinematic viscosity at −30° C. of equal to or less than 1800 mm²/s, and/or less than 150 mm²/s.

15. The electrotechnical fluid composition according to claim 10, wherein the electrotechnical fluid composition has a flash point of equal to or more than 135° C.

16. The electrotechnical fluid composition according to claim 10, wherein the electrotechnical fluid composition has a total acidity of equal to or less than 0.01 mg KOH/g.

17. The electrotechnical fluid composition according to claim 10, wherein the electrotechnical fluid composition has a water content of equal to or less than 30 mg/kg, and/or less than 20 mg/kg.

18. The electrotechnical fluid composition according to claim 10, wherein the electrotechnical composition comprises:
from 0.01 to 5 wt-%, and/or from 0.01 to 4 wt-%, C15 paraffins, based on a total weight of the composition.

19. The electrotechnical fluid composition according to claim 10, wherein the electrotechnical composition comprises:
from 5 to 35 wt-%, and/or from 18 to 32 wt-%, C16 paraffins, based on a total weight of the composition.

20. The electrotechnical fluid composition according to claim 10, wherein the electrotechnical composition comprises:
from 5 to 24 wt-%, preferably and/or from 10 to 22 wt-%, C17 paraffins, based on a total weight of the composition

21. The electrotechnical fluid composition according to claim 10, wherein the electrotechnical composition comprises:
from 5 to 23 wt-%, and/or from 8 to 21 wt-%, C18 paraffins, based on a total weight of the composition.

22. The electrotechnical fluid composition according to claim 10, wherein the electrotechnical composition comprises:
from 5 to 23 wt-%, and/or from 8 to 21 wt-%, C19 paraffins based on a total weight of the composition.

23. The electrotechnical fluid composition according to claim 10, wherein the electrotechnical composition comprises:
from 5 to 19 wt-%, and/or from 8 to 17 wt-%, C20 paraffins based on a total weight of the composition.

24. The electrotechnical fluid composition according to claim 10, wherein the electrotechnical composition comprises:
from 1 to 12 wt-%, preferably and/or from 2 to 10 wt-%, C21 paraffins based on a total weight of the composition.

25. The electrotechnical fluid composition according to claim 10, wherein the electrotechnical composition comprises:
from 0.1 to 12 wt-%, and/or from 0.3 to 10 wt-%, C22 paraffins based on a total weight of the composition.

26. The electrotechnical fluid composition according to claim 10, wherein the electrotechnical composition comprises:
from 0.05 to 14 wt-%, and/or from 0.05 to 10 wt-%, C23 paraffins based on a total weight of the composition.

27. The electrotechnical fluid composition according to claim 10, wherein the electrotechnical composition comprises:
less than 8 wt-%, and/or less than 7 wt-%, and/or less than wt-%, and/or less than 0.1 wt-%, C24 paraffins based on a total weight of the composition.

28. The electrotechnical fluid composition according to claim 10, wherein the total isoparaffinic content of the composition is more than 93 wt-% but less than 99 wt-%, and/or more than 94 wt-% but less than 98 wt-%, and/or more than 95 wt-% but less than 97 wt-%, based on a total weight of the composition.

29. The electrotechnical fluid composition according to claim 10, wherein a weight ratio of an amount of i-paraffins to an amount of n-paraffins is more than 20, based on a total weight of the composition.

30. The electrotechnical fluid composition according to claim 10, wherein a weight ratio of an amount of i-paraffins to an amount of n-paraffins is less than 32, based on a total weight of the composition.

31. The electrotechnical fluid composition according to claim 10, wherein the electrotechnical fluid has:
kinematic viscosity at 40° C. as measured according to ENISO 3104 of equal to or less than 12 mm²/s, and/or between 3 and 4.5 mm²/s,
kinematic viscosity at −30° C. as measured according to ENISO 3104 of equal to or less than 1800 mm²/s, and/or below 120 mm²/s,
flash point (PM) as measured according to ENISO 2719 of equal to or more than 135° C., and/or at least 137° C., and
acidity of equal to or less than 0.3 mg KOH/g, and/or below 0.009 mg KOH/g.

32. The electrotechnical fluid composition according to claim 10, wherein the electrotechnical fluid has:
kinematic viscosity at 40° C. as measured according to ENISO 3104 of equal to or less than 12 mm²/s, and/or between 4 and 8 mm²/s,
kinematic viscosity at −30° C. as measured according to ENISO 3104 of equal to or less than 1800 mm²/s, and/or below 500 mm²/s,
flash point (PM) as measured according to ENISO 2719 of at least 135° C., and/or at least 135° C., and
acidity of equal to or less than 0.3 mg KOH/g, and/or 0.002 mg KOH/g.

33. An electrotechnical fluid composition according to claim 10, in combination with:
a transformer, and/or a power transformer.

34. An electrotechnical fluid composition according to claim 10, in combination with:
a transformer oil and/or as a component of transformer oil, battery coolant, heat transfer fluid, coolant, insulating oil, chock absorbing fluid or a cable oil.

35. An electrotechnical fluid composition according to claim 10, in combination with:
an electric vehicle battery coolant.

36. An electrotechnical fluid composition according to claim 10, in combination with:
a server farm coolant.

37. An electrotechnical fluid composition, comprising:
more than 95 wt-%, and/or more than 97 wt-%, and/or more than 99 wt-%, paraffins in a C15-C29 range, and/or in a C15-C25 range, based on a total weight of the composition; and
wherein the electrotechnical composition fulfils requirements according to IEC60296(2012).
